(19) United States
(12) Patent Application Publication
(10) Pub. No.: US 2012/0182898 A1
(43) Pub. Date: Jul. 19, 2012

(54) METHOD AND SYSTEM FOR TRANSMITTING DOWNLINK DATA VIA A RELAY

(75) Inventor: Lei Mao, Shenzhen City (CN)

(73) Assignee: ZTE CORPORATION, Shenzhen City, Guangdong (CN)

(21) Appl. No.: 13/384,832

(22) PCT Filed: Jun. 7, 2010
(86) PCT No.: PCT/CN2010/073630

§ 371 Date: Jan. 19, 2012

(30) Foreign Application Priority Data
Sep. 23, 2009 (CN) 200910178101.7

(51) Int. Cl. H04W 52/04; H04W 24/00

(52) U.S. Cl. 370/252

(57) ABSTRACT

A method and system for transmitting downlink data via a relay, and a relay are provided by the present invention. The system includes an evolved node B and a relay. The evolved node B is set to determine power parameters of a terminal according to a downlink transmission power from the rely to the terminal, and to inform the terminal of the power parameters; the rely is set to perform the signal transmission to the terminal according to the downlink transmission power; the terminal demodulates the signal received from the evolved node B and/or the rely according to the power parameters. Application of the present invention enhances the transmission performance of the system, and resolves the problem of setting the transmission power for the relay node.

### TECHNICAL FIELD

The present invention relates to the field of wireless communications, and in particular, to a method and system for transmitting downlink data via a relay in a Long Term Evolution-Advanced (LTE-A for short) system.

### BACKGROUND OF THE RELATED ART

In 2005, the 3rd Generation Partnership Project (3GPP) started a working group studying the Long Term evolution (LTE), which studied and designed the next generation network of the 3rd generation mobile communication technology evolved 3.9G (advanced 3G).

LTE uses an air interface technology which is different from the 3rd generation mobile communication technology (3G for short). With the Orthogonal Frequency Division Multiplexing (OFDM for short) technology based air interface design, the packet switching based design concept is used in the system, i.e., a shared channel is used, and the physical layer no longer provides a dedicated channel. The system supports two dulplexing modes, i.e., Frequency-Division Duplexing (FDD for short) and Time Division Duplexing (TDD for short). Meanwhile, the architecture of the traditional 3G network is optimized. A flat network structure is used, the access network includes only an evolved node B (eNodeB), and no longer includes a Radio Network Controller (RNC for short).

As shown in FIG. 1, the LTE system is comprised of three parts, i.e., an Evolved Packet Core (EPC for short), an Evolved Universal Terrestrial Radio Access Network (E-UTRAN for short) and a User Equipment (UE). The EPC includes Mobility Management Entities (MME for short) which are responsible for signaling processing of the EPC. A data processing entity is called as a Service Gateway (S-GW for short), and the access network includes evolved NodeBs (eNodeB).

Functions of the eNodeB include: radio resource management functions, IP header compression and user data stream encryption, MME selection during attachment of the UE, scheduling transmission of paging information, scheduling transmission of broadcast information, and setting and providing measurements of the eNB, and so on.

Functions of the MME include: paging message transmission, security control, mobility management in an idle state, SAE bearer management, and encryption and integrity protection of non-access layer signaling, and so on.

Functions of the S-GW include: data routing and transmission, and encryption of user plane data.

In the LTE system, the eNodeB is connected to the EPC via a S1 interface, the eNodeBs are connected via an X2 interface and the eNodeB is connected to the UE via a Uu interface. Compared to the Universal Mobile Telecommunications System (UMTS for short), the Iub interface is not required in the LTE system, as the evolved base station and the RNC are integrated as a network element eNodeB in the LTE system. The X2 interface is similar to the Iur interface, except for a greater simplification, and the S1 interface is similar to the Iu interface, except for a greater simplification.

The Long Term Evolution-Advanced (LTE-A) system is a standard released by the 3GPP in order to meet the requirements of the International Telecommunication Union (ITU for short) on IMT-Advanced (4G). In March 2008, 3GPP passed LTE-Advanced related research projects, which further improves the technology of the LTE system with the goal of meeting and exceeding the technical requirements of the ITU on the IMT-Advanced, and achieves backward compatibility of the LTE. The LTE-Advanced is used as a candidate technology of the IMT-Advanced submitted to the ITU by the 3GPP.

Obviously, the LTE system has become one of primary candidate technologies of the IMT-advanced, since the LTE system stands for the main direction of development of new mobile communication technologies. The LTE itself can be used as the technique basis and core meeting the requirements of the IMT-Advanced, except that compared with the requirements of the IMT-Advanced, the LTE still has a gap in terms of indices. Therefore, when the LTE is upgraded to the 4G, the core of the LTE standard is not required to be changed and only required to be expanded, enhanced and improved on the basis of the LET so as to satisfy the requirements of the IMT-Advanced. The mainly introduced new technologies include enhancement technologies such as relay, Coordinated Multi-Point (COMP) transmission, Carrier Aggregation (CA), etc.

In order to improve coverage gain at boundaries of a cell and achieve blind compensation effect, a relay technology is introduced in the LTE-Advanced in the 3GPP. An eNodeB not only provides services to the UE of its cell, but also performs data transmission and signaling interaction with a number of relays under its control. Likewise, each relay not only communicates with the eNB, but also provides services to the UE under the relay. The link from the eNB to the relay can use the same frequency resources as those used by the link from the relay to the UE which is served by the relay, which is called an in-band relay, and can use different frequency resources than those used by the link from the relay to the UE which is served by the relay, which is called an out-band relay.

In the discussion of the 3GPP, two types of relays, i.e., Type1 Relay and Type2 Relay, are finally determined based on whether a relay node has independent cell Identifier (ID).

### Type1 Relay:

For the UE, the Type1 Relay is an independent cell, has its own physical cell ID, and transmits its own synchronization channel and reference symbol; the Type1 Relay performs scheduling and Hybrid Automatic Repeat reQuest (HARQ for short) functions; and for the R8 UE, the Type1 Relay is a R8 eNB.

### Type2 Relay:

The Type2 Relay does not have independent physical cell ID, and does not transmit control information and reference symbol, and the R8 UE cannot see the presence of the Type2 Relay. The Type2 Relay primarily assists the eNB in transmitting and receiving service data.

At present, the process of downlink power control in the LTE system is as follows: the eNB determines transmission power of each Physical Resource Block (PRB for short) in the downlink. The Energy Per Resource Element (EPRE) of a downlink Cell-specific Reference Signal (CRS for short) in the cell is fixed, and is informed to the UE by the eNB through a physical downlink shared channel configuration message carrying Reference-signal-power. The ratio of EPRE to CRS EPRE of the Physical Downlink Shared Channel (PDSCH) is denoted as ρ_{A} or ρ_{B} (an OFDM symbol identifier is determined to be ρ_{A} or ρ_{B} according to the following table), where ρ_{A} and ρ_{B} are UE specific parameters.

| The number of | denoted as ρ_{A} | | denoted as ρ_{B} | |
|---|---|---|---|---|
| antenna ports | Normal CP | Extended CP | Normal CP | Extended CP |
| 1 or 2 | 1, 2, 3, 5, 6 | 1, 2, 4, 5 | 0, 4 | 0, 3 |
| 4 | 2, 3, 5, 6 | 2, 4, 5 | 0, 1, 4 | 0, 1, 3 |

When the modulation mode is 16 Quadrature Amplitude Modulation (QAM) or 64 QAM, a spatial multiplexing, Multiple-Input Multiple-Output (MIMO) transmission mode for more than one layer is as follows:

ρ_{A}=δ_{power-offset}+P_{A}+10log₁₀ (2) [dB]

In other cases ρ_{A}=δ_{power-offset}+P_{A} [dB]

Here, δ_{power-offset} is 0 dB for the modes except for the multi-user MIMO mode; P_{A}=EA/ERS is the ratio of transmission power of a data sub-carrier in an OFDM symbol without a pilot to pilot power, and is configured by a higher layer.

ρ_{B}/ρ_{A} is configured by the higher layer based on a cell specific parameter P_{B} according to the following table.

P_{B}=EB/EA is the ratio of transmission power of a data sub-carrier in an OFDM symbol containing a pilot to transmission power of a data sub-carrier in an OFDM symbol without a pilot.

ρ_{B}/ρ_{A}

| P_{B} | One antenna interface | Two or four antenna interfaces |
|---|---|---|
| 0 | 1 | 5/4 |
| 1 | ⅘ | 1 |
| 2 | ⅗ | ¾ |
| 3 | ⅖ | ½ |

At present, the influence of addition of a relay node on the LTE system is not considered in the process of downlink power control of the system, and the problem of controlling the transmission power of the relay node is not provided.

### CONTENT OF THE INVENTION

The technical problem to be solved by the present invention is to provide a method and system for transmitting downlink data via a relay so as to adapt to the characteristics of the relay and enhances the transmission performance of the system.

In order to solve the above problem, the present invention provides a system for transmitting downlink data via a relay comprising an evolved NodeB and a relay, wherein the evolved NodeB is configured to determine power parameters of a terminal based on downlink transmission power from the relay to the terminal, and to inform the terminal of the power parameters; and the relay is configured to transmit a signal to the terminal based on the downlink transmission power such that the signal received from the evolved NodeB and/or the relay is demodulated by the terminal based on the power parameters.

The system is further characterized in that:

the evolved NodeB is further configured to determine the downlink transmission power from the relay to the terminal, and to inform the relay of the downlink transmission power.

The system is further characterized in that:

the evolved NodeB is further configured to inform the relay of the downlink transmission power from the relay to the terminal after determining the downlink transmission power, and inform the relay of only an offset value of the downlink transmission power when the downlink transmission power is in a form of offset; and

the relay is further configured to use a sum of a fixed value of the downlink transmission power appointed by both parties and the received offset value as the downlink transmission power to the terminal after receiving the offset value of the downlink transmission power transmitted by the evolved NodeB.

The system is further characterized in that:

the relay is further configured to determine the downlink transmission power from the relay to the terminal and inform the evolved NodeB of the downlink transmission power.

The system is further characterized in that:

the evolved NodeB is further configured to use the sum of the fixed value of the downlink transmission power appointed by both parties and the received offset value as the downlink transmission power from the relay to the terminal after receiving the offset value of the downlink transmission power transmitted by the relay; and

the relay is further configured to inform the evolved NodeB of the downlink transmission power from the relay to the terminal after determining the downlink transmission power, and inform the evolved NodeB of only the offset value of the downlink transmission power when the downlink transmission power is in the form of offset.

The system is further characterized in that:

the downlink transmission power from the relay to the terminal is fixed downlink transmission power.

In order to solve the above technical problem, the present invention further provides a method for transmitting downlink data via a relay comprising: determining, by an evolved NodeB, power parameters of a terminal based on downlink transmission power from the relay to the terminal, and informing the terminal of the power parameters; transmitting, by the relay, a signal to the terminal based on the downlink transmission power; and demodulating the signal received from the evolved NodeB and/or the relay based on the power parameters.

The method is further characterized in that:

the downlink transmission power from the relay to the terminal is determined and informed to the relay by the evolved NodeB; or the downlink transmission power from the relay to the terminal is determined by the relay itself, and the downlink transmission power is informed to the evolved NodeB by the relay; or the downlink transmission power to the terminal is determined by the relay to be fixed downlink transmission power of a system.

The method is further characterized in that:

the evolved NodeB transmits power configuration parameters containing a terminal identifier to the relay and transmits a resource position of a signal and the downlink transmission power to the terminal, when the downlink transmission power from the relay to the terminal is determined and informed to the relay by the evolved NodeB; or

the relay reports a terminal identifier and the downlink transmission power to the evolved NodeB when the downlink transmission power from the relay to the terminal is determined by the relay itself and the downlink transmission power is informed to the evolved NodeB by the relay.

The method is further characterized in that:

when the evolved NodeB informs the relay of the downlink transmission power from the relay to the terminal after determining the downlink transmission power, the method is specifically that: the evolved NodeB informs the relay of only an offset value of the downlink transmission power when the downlink transmission power is in a form of offset, and uses a sum of a fixed value of the downlink transmission power appointed by both parties and the received offset value as the downlink transmission power to the terminal after the relay receives the offset value; or

when the relay informs the evolved NodeB of the downlink transmission power from the relay to the terminal after determining the downlink transmission power, the method is specifically that: the relay informs the evolved NodeB of only an offset value of the downlink transmission power when the downlink transmission power is in the form of offset, and uses a sum of a fixed value of the downlink transmission power appointed by both parties and the received offset value as the downlink transmission power to the terminal after the evolved NodeB receives the offset value.

The present invention further provides a relay configured to transmit a signal to a terminal based on downlink transmission power; wherein

the signal received from an evolved NodeB and/or the relay is demodulated by the terminal based on power parameters; and

the power parameters are determined by the evolved NodeB based on the downlink transmission power from the relay to the terminal, and are informed to the terminal.

the relay is further configured to use a sum of a fixed value of the downlink transmission power appointed by both parties and a received offset value as the downlink transmission power to the terminal after receiving the offset value of the downlink transmission power transmitted by the evolved NodeB; and

the downlink transmission power for the terminal is determined and informed to the relay by the evolved NodeB; and the offset value of the downlink transmission power is informed only to the relay when the downlink transmission power is in a form of offset.

The relay is further configured to inform the evolved NodeB of the downlink transmission power from the relay to the terminal after determining the downlink transmission power, and inform the evolved NodeB of only the offset value of the downlink transmission power when the downlink transmission power is in the form of offset;

such that the sum of the fixed value of the downlink transmission power appointed by both parties and the received offset value is used as the downlink transmission power from the relay to the terminal after the evolved NodeB receives the offset value of the downlink transmission power transmitted by the relay.

The downlink transmission power from the relay to the terminal is fixed downlink transmission power.

In a scene where a relay exists in the LTE-A system, the present invention designs a method suitable to set and transmit transmission power parameters of the relay based on characteristics of the relay so as to adapt to the characteristics of the relay, enhance the transmission performance of the system, and solves the problem of setting the transmission power of the relay node.

### BRIEF DESCRIPTION OF DRAWINGS

FIG. 1 is a diagram of a composition structure of a LTE system in the existing technology; and

FIG. 2 is a flow chart of a method for transmitting downlink data via a relay in accordance with an embodiment.

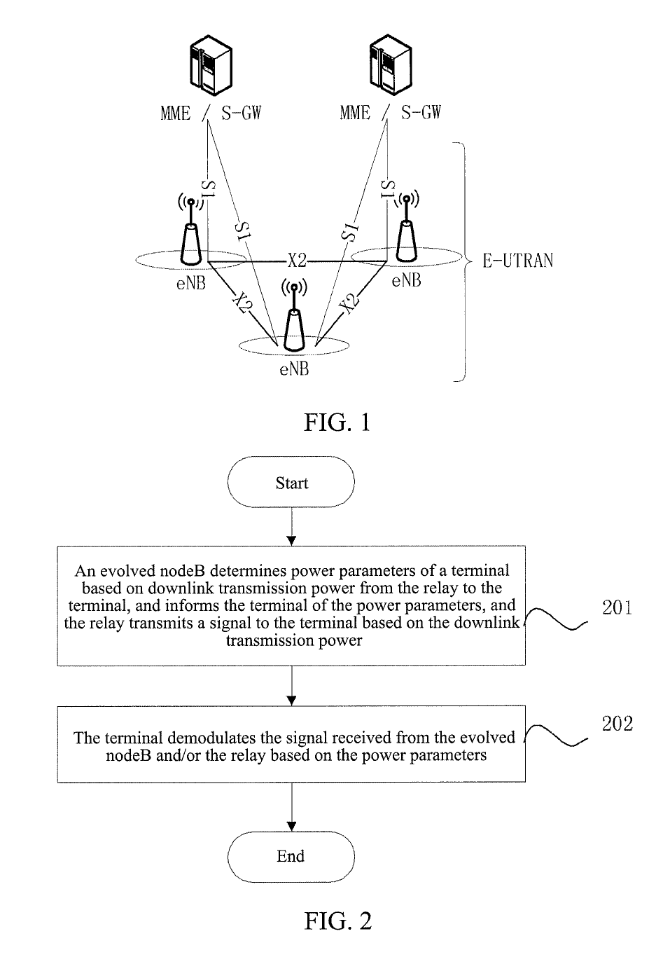

### PREFERRED EMBODIMENTS OF THE PRESENT INVENTION

As shown in FIG. 2, the method for transmitting downlink data via a relay comprises the following steps.

Step 201: an evolved NodeB determines power parameters of a terminal based on downlink transmission power from the relay to the terminal, and to inform the terminal of the power parameters; and the relay transmits a signal to the terminal based on the downlink transmission power.

Step 202: the signal received from the evolved NodeB and/or the relay is demodulated by the terminal based on the power parameters.

### THE FIRST EMBODIMENT

The downlink power control in the existing system is determined inside the eNB; if the computation mode of the eNB is still used, the eNB is needed to determine the downlink transmission power from the relay to a certain terminal and inform the relay of the downlink transmission power. The method in accordance with the first embodiment comprises the following steps.

Step 101: the eNB determines the downlink transmission power from the relay to a certain service terminal and transmission power of the eNB.

The eNB determines the downlink transmission power from the relay to the terminal based on parameters of the relay and/or parameters of the terminal. The downlink transmission power may be determined through a plurality of specific algorithms, which will not be described in detail here, or may be determined by manufacturers.

The determined downlink transmission power value is in a form of fixed value when the eNB informs the relay of the downlink transmission power value (the downlink transmission power transmitted by the eNB is an absolute value of the downlink transmission power used by the relay), and the downlink transmission power value received by the relay is used as the downlink transmission power to the terminal. The determined downlink transmission power value may also be in a form of offset, that is, the eNB and the relay appoint the fixed value of the downlink transmission power, and the eNB informs only an offset value of the downlink transmission power, and the sum of the fixed value of the downlink transmission power appointed by both parties and the received offset value is used as the downlink transmission power to the terminal after the relay receives the offset value.

Step 102: the eNB informs the relay of the determined downlink transmission power to the terminal.

The eNB transmits power configuration parameters containing a terminal identifier to the relay and transmits a resource position of a signal and the downlink transmission power to the terminal.

Step 103: the eNB determines the power parameters of the terminal based on the downlink transmission power from the relay to the terminal and informs the terminal of the power parameters.

The power parameters include Pa and Pb; in the practical system, a fixed Pa value may be roughly configured based on different cell types or scenes and be informed to the relay through Un interface signaling configuration. However, Pa is terminal specific (i.e., each terminal is configured individually with a Pa), and Pa needs to be configured for position shifting of the terminal and to be timely informed to the terminal such that the received signal can be demodulated by the terminal and perform CQI measurement on the received signal. In the process, as the relay cannot transmit signaling to the terminal, the eNB is needed to amend the configured Pa parameters in consideration of the influence of the relay when configuring the power parameters in the original signaling. There may be a plurality of the methods for the eNB to determine the power parameters of the terminal based on the downlink transmission power from the relay to the terminal, which will not be described in detail here, or the power parameters of the terminal may be determined by manufacturers.

Step 104: the eNB transmits a signal to the terminal based on the transmission power computed by itself, and the relay transmits a signal to the terminal on resources configured by the eNB based on the downlink transmission power configured by the eNB.

Step 105: the signal received from the eNB and/or the relay is demodulated by the UE based on the downlink transmission power configured by the eNB and performs corresponding measurements.

### THE SECOND EMBODIMENT

The relay independently determines the downlink transmission power from the relay to the terminal, and informs the eNB of the downlink transmission power. The method in accordance with the second embodiment comprises the following steps.

Step 201: the eNB informs the relay to transmit a signal to a certain user.

Step 202: the relay determines the downlink transmission power from the relay to a certain service terminal.

The relay determines the downlink transmission power from the relay to the terminal based on parameters of the relay and/or parameters of the terminal. The downlink transmission power may be determined through a plurality of specific algorithms, which will not be described in detail here, or may be determined by manufacturers.

Step 203: the relay reports the determined downlink transmission power to the eNB; and the relay further reports the terminal identifier while reporting the determined downlink transmission power to the eNB.

When the determined downlink transmission power value reported by the relay is in the form of fixed value (the downlink transmission power transmitted by the relay is an absolute value of the downlink transmission power used by the relay), the received downlink transmission power value is used by the eNB as the downlink transmission power to the terminal. the determined downlink transmission power value may also be in the form of offset, that is, the eNB and the relay appoint the fixed value of the downlink transmission power, and the relay informs only an offset value of the downlink transmission power, and the sum of the fixed value of the downlink transmission power appointed by both parties and the received offset value is used as the downlink transmission power to the terminal after the eNB receives the offset value.

Step 204: the eNB determines the power parameters of the terminal based on the downlink transmission power from the relay to the terminal, and informs the terminal of the power parameters.

The power parameters include Pa and Pb; the eNB amends the configured Pa parameters in consideration of the influence of the relay when configuring the power parameters in the original signaling. There may be a plurality of the methods for the eNB to determine the power parameters of the terminal based on the downlink transmission power from the relay to the terminal, which will not be described in detail here, or the power parameters of the terminal may be determined by manufacturers.

Step 205: the eNB transmits a signal to the terminal based on the transmission power computed by itself, and the relay transmits a signal to the terminal on resources configured the eNB based on the downlink transmission power determined by itself.

Step 206: the signal received from the eNB and/or the relay is demodulated by the UE based on power parameters configured by the eNB and performs corresponding measurements.

### THE THIRD EMBODIMENT

The downlink transmission power from the relay to the terminal may also be fixed transmission power set by the system. The method in accordance with the third embodiment comprises the following steps.

Step 301: the relay determines the fixed transmission power set by the system to be the downlink transmission power to a certain terminal; wherein the fixed transmission power may be pre-configured by an operator, and the eNB acquires the fixed transmission power at the same time.

Step 302: the eNB determines the power parameters of the terminal and informs the terminal of the power parameters.

The eNB determines whether the relay participates in communication with the terminal, and if so, the eNB determines the power parameters of the terminal based on the downlink transmission power from the relay to the terminal, and informs the terminal of the power parameters. The eNB amends the configured Pa parameters in consideration of the influence of the relay when configuring the power parameters in the original signaling. There may be a plurality of the methods for the eNB to determine the power parameters of the terminal based on the downlink transmission power from the relay to the terminal, which will not be described in detail here, or the power parameters of the terminal may be determined by manufacturers.

Step 303: the eNB transmits a signal to the terminal based on the transmission power computed by itself, and the relay transmits a signal to the terminal on resources configured by the eNB based on the fixed downlink transmission power.

Step 304: the signal received from the eNB and/or the relay is demodulated by the UE based on power parameters configured by the eNB and performs corresponding measurements.

In a scene where a relay exists in the LTE-A system, the present invention provides a new solution for transmission of downlink data via a relay, and considering the case where the relay transmits downlink data to the terminal, the eNB side amends the power parameters of the terminal, and adjusts the power parameters of the terminal so as to adapt to the characteristics of the relay, enhance the transmission performance of the system, and solve the problem of setting the transmission power of the relay node.

The above description is only the preferred embodiments of the present invention and is not intended to limit the present invention. Various modifications and variations to the present invention may be made by those skilled in the art. Any modification, equivalent substitution and improvement made within the spirit and principle of the present invention should be covered within the protection scope of the present invention.

### INDUSTRIAL APPLICABILITY

In a scene where a relay exists in the LTE-A system, the present invention designs a method suitable to set and transmit transmission power parameters of the relay based on characteristics of the relay so as to adapt to the characteristics of the relay, enhance the transmission performance of the system, and solves the problem of setting the transmission power of the relay node.

What we claim is:

1. A system for transmitting downlink data via a relay comprising an evolved NodeB and a relay, wherein
the evolved NodeB is configured to determine power parameters of a terminal based on downlink transmission power from the relay to the terminal, and to inform the terminal of the power parameters; and
the relay is configured to transmit a signal to the terminal based on the downlink transmission power such that the signal received from the evolved NodeB and/or the relay is demodulated by the terminal based on the power parameters.

2. The system according to claim 1, wherein
the evolved NodeB is further configured to determine the downlink transmission power from the relay to the terminal, and to inform the relay of the downlink transmission power.

3. The system according to claim 2, wherein
the evolved NodeB is further configured to inform the relay of the downlink transmission power from the relay to the terminal after determining the downlink transmission power, and inform the relay of only an offset value of the downlink transmission power when the downlink transmission power is in a form of offset; and
the relay is further configured to use a sum of a fixed value of the downlink transmission power appointed by both parties and the received offset value as the downlink transmission power to the terminal after receiving the offset value of the downlink transmission power transmitted by the evolved NodeB.

4. The system according to claim 1, wherein
the relay is further configured to determine the downlink transmission power from the relay to the terminal and inform the evolved NodeB of the downlink transmission power.

5. The system according to claim 4, wherein
the evolved NodeB is further configured to use the sum of the fixed value of the downlink transmission power appointed by both parties and the received offset value as the downlink transmission power from the relay to the terminal after receiving the offset value of the downlink transmission power transmitted by the relay; and
the relay is further configured to inform the evolved NodeB of the downlink transmission power from the relay to the terminal after determining the downlink transmission power, and inform the evolved NodeB of only the offset value of the downlink transmission power when the downlink transmission power is in the form of offset.

6. The system according to claim 1, wherein
the downlink transmission power from the relay to the terminal is fixed downlink transmission power.

7. A method for transmitting downlink data via a relay comprising:
determining, by an evolved NodeB, power parameters of a terminal based on downlink transmission power from the relay to the terminal, and informing the terminal of the power parameters;
transmitting, by the relay, a signal to the terminal based on the downlink transmission power; and
demodulating the signal received from the evolved NodeB and/or the relay based on the power parameters.

8. The method according to claim 7, wherein
the downlink transmission power from the relay to the terminal is determined and informed to the relay by the evolved NodeB; or
the downlink transmission power from the relay to the terminal is determined by the relay itself, and the downlink transmission power is informed to the evolved NodeB by the relay; or
the downlink transmission power to the terminal is determined by the relay to be fixed downlink transmission power of a system.

9. The method according to claim 8, wherein
the evolved NodeB transmits power configuration parameters containing a terminal identifier to the relay and transmits a resource position of a signal and the downlink transmission power to the terminal, when the downlink transmission power from the relay to the terminal is determined and informed to the relay by the evolved NodeB; or
the relay reports a terminal identifier and the downlink transmission power to the evolved NodeB when the downlink transmission power from the relay to the terminal is determined by the relay itself and the downlink transmission power is informed to the evolved NodeB by the relay.

10. The method according to claim 8, wherein
when the evolved NodeB informs the relay of the downlink transmission power from the relay to the terminal after determining the downlink transmission power, the method is specifically that: the evolved NodeB informs the relay of only an offset value of the downlink transmission power when the downlink transmission power is in a form of offset, and uses a sum of a fixed value of the downlink transmission power appointed by both parties and the received offset value as the downlink transmission power to the terminal after the relay receives the offset value; or
when the relay informs the evolved NodeB of the downlink transmission power from the relay to the terminal after determining the downlink transmission power, the method is specifically that: the relay informs the evolved NodeB of only an offset value of the downlink transmission power when the downlink transmission power is in the form of offset, and uses a sum of a fixed value of the downlink transmission power appointed by both parties and the received offset value as the downlink transmission power to the terminal after the evolved NodeB receives the offset value.

11. A relay configured to transmit a signal to a terminal based on downlink transmission power; wherein
the signal received from an evolved NodeB and/or the relay is demodulated by the terminal based on power parameters; and
the power parameters are determined by the evolved NodeB based on the downlink transmission power from the relay to the terminal, and are informed to the terminal.

12. The relay according to claim 11, wherein the relay is further configured to use a sum of a fixed value of the downlink transmission power appointed by both parties and a received offset value as the downlink transmission power for the terminal after receiving the offset value of the downlink transmission power transmitted by the evolved NodeB; and
the downlink transmission power for the terminal is determined and informed to the relay by the evolved NodeB; and the offset value of the downlink transmission power is informed only to the relay when the downlink transmission power is in a form of offset.

13. The relay according to claim 11, wherein the relay is further configured to inform the evolved NodeB of the downlink transmission power from the relay to the terminal after determining the downlink transmission power, and inform the evolved NodeB of only the offset value of the downlink transmission power when the downlink transmission power is in the form of offset;
such that the sum of the fixed value of the downlink transmission power appointed by both parties and the received offset value is used as the downlink transmission power from the relay to the terminal after the evolved NodeB receives the offset value of the downlink transmission power transmitted by the relay.

14. The relay according to claim 11, wherein the downlink transmission power from the relay to the terminal is fixed downlink transmission power.
